(19) United States
(12) Patent Application Publication
(10) Pub. No.: US 2018/0117733 A1
(43) Pub. Date: May 3, 2018

(54) BALANCER

(71) Applicant: Carl Stahl Kromer GmbH, Gottenheim (DE)

(72) Inventor: Thomas Steinle, Hartheim (DE)

(21) Appl. No.: 15/793,713

(22) Filed: Oct. 25, 2017

(30) Foreign Application Priority Data
Oct. 27, 2016 (DE) 10 2016 120 564.8

(51) Int. Cl. B24B 41/04; B25J 19/00; B25H 1/00; G01G 3/06; F16F 1/12

(52) U.S. Cl. CPC B24B 41/042; B25J 19/0016; G05G 2700/14; G01G 3/06; F16F 1/128; B25H 1/0028

(57) ABSTRACT

The invention relates to a balancer (1) for a movable component with a component weight, having a spindle mechanism (32), on the rotation element (34) of which the component can be suspended, and at least one compression spring (30) which is connected, at one of its ends (29), to a translation element (36) of the spindle mechanism, wherein the compression spring is able to be compressed by means of the translation element in the event of a rotation of the rotation element brought about by the component weight.

### BACKGROUND OF THE INVENTION

Balancers such as spring balancers or zero-gravity balancers are used to balance the dead weight of a component to be handled, such that the person using the component does not have to bear the weight thereof. This is relevant for example in production facilities in which heavy tools need to be used for particular production steps. In order that the manufacturer does not have to permanently bear the weight of the corresponding tool while using the latter, but rather can concentrate on the fine-motor use of the tool, said balancers are used.

To this end, the balancer can be suspended for example on a crossbeam in the roof structure and the component to be balanced can for its part be suspended on the balancer.

Known balancers have a spiral spring which, after the component has been suspended, is deflected until the bending deflection of the spiral spring entails such a strong spring force that the weight force of the suspended component is compensated.

Normally, in these known balancers, the component is fastened to a cable by way of a snap hook, the other end of said cable in turn being fastened to the outer end of the spiral spring. The inner end of the spiral spring is arranged in a rotationally fixed manner on a carrier of the known balancer, wherein the carrier for its part can be fastened to a roof beam by means of a cable and/or a snap hook. The equilibrium that is thus established with a suspended component allows an operator to handle the component without having to continuously apply a holding force equivalent to the weight force thereof.

The use of spiral springs for weight compensation allows a simple structure. However, on account of the nature of spiral springs, the maximum loads that are able to be balanced—with regard to the overall size of the balancer—are relatively low. In addition, the increase in the spring force at a particular deflection is dependent on the bending of the spiral spring that has already taken place. This makes it difficult for example to set a desired preload for adaptation to a component weight to be expected.

The problem addressed by the invention is that of providing a balancer that is usable in a greater weight range and is preferably easier to install.

### BRIEF DESCRIPTION OF THE INVENTION

This problem is solved by the invention specified in the independent claim. Advantageous developments can be gathered from the dependent claims.

Created according to the invention is a balancer, in particular a spring balancer or a zero-gravity balancer, for a movable component with a component weight, having a spindle mechanism with a translation element and a rotation element, on which the component can be suspended, and at least one compression spring which is—at least indirectly—connected, at one of its ends, to the translation element of the spindle mechanism. The compression spring is able to be compressed by means of the translation element in the event of a rotation of the rotation element brought about by the component weight.

The invention is based, inter alia, on the idea that compression springs, which are subjected to compressive load along their longitudinal axis, exhibit an increase in spring force that is proportional to the deflection along the longitudinal axis, in other words a linear spring force profile. This distinguishes compression springs from the spiral springs which have been used hitherto in balancers and which are not subjected to compressive load upon deflection but rather are subjected to bending load about their longitudinal axis. Therefore, spiral springs do not have a linear force profile, this, however, being advantageous for the design of the balancer, in particular for the adaptation thereof to a particular weight of the component to be balanced.

In addition, compression springs for use in balancers can be designed such that it is also possible to absorb very large weight forces and/or a large weight-force range therewith. This too is difficult with spiral springs, because the latter contract rapidly about their central axis upon deflection and so, from a certain deflection, the individual layers rest against one another and no further deflection is possible.

The invention is also based on the finding that, on account of the typical applications of balancers, the use of compression springs therein requires a gear mechanism: Balancers are typically suspended over the desired work area and balance a weight force which necessarily acts downwardly. Therefore, when compression springs are used to apply a spring force counteracting the weight force, a tensile force has to be converted into a compressive force. Within the meaning of the invention, this takes place by means of the spindle mechanism, which can convert rotary movements (at the rotation element) into longitudinal movements (at the translation element). A thread, in particular with a predefined thread pitch, which imparts this conversion, is preferably arranged between the rotation element and the translation element.

A compression spring within the meaning of the invention is preferably a cylindrical coil spring which can deflect along its longitudinal axis in the event of compressive load.

The term balancer is used here as a collective term, inter alia, for spring balancers and zero-gravity balancers, and is geared to the function of these devices: compensation of the weight force of the component to be balanced. Spring balancers (also known as retractors) is the name frequently given to balancers for relatively low loads, in which the function of pulling near and retracting the suspended load is also often important. Zero-gravity balancers is the name frequently given to balancers for relatively high loads, in which, functionally, weight compensation is often paramount. Therefore, zero-gravity balancers are also—in a narrower sense than that used here—known as balancers.

Because conventional trapezoidal threads frequently tend towards self-locking, which can be reduced at best by extremely precise tolerances and/or elaborate lubrication, in one configuration of the invention, the spindle has a movement thread, in particular a ball screw or a roller screw. Such movement threads can be designed for example in a play-free manner and as a result have in particular a lower tendency towards self-locking. Generally, movement threads exhibit less friction between the bearing partners than conventional threads and are therefore suitable for the present application.

Whether, in the spindle mechanism used, the spindle is embodied as the rotation element and the spindle nut as the translation element or vice versa is irrelevant per se for the operating principle of the invention. Nevertheless, in different configurations of the invention, these two alternatives are provided because, depending on the configuration of the rest of the balancer, one or the other alternative may have for example advantages with regard to the force flow, easy production and/or an optionally provided setting device for setting a preload of the compression springs.

In order to allow easy force transmission between the compression spring and the spindle mechanism, in one configuration of the invention, the compression spring and the translation element are connected by means of an abutment element which butts against one end of the compression spring and is firmly connected to the translation element. In an embodiment having a plurality of compression springs, the abutment element can be configured, for example, as a solid disc welded to the translation element, said disc being able to press the compression springs arranged in the circumference of the translation element at their respective ends facing the abutment element.

In order that, by means of the spindle mechanism, a pressure force can be exerted effectively on the compression spring, according to one configuration of the invention, a longitudinal axis of movement of the translation element extends parallel to the longitudinal axis of the compression spring.

In order to avoid any twisting of the compression spring(s) during operation, in one configuration of the invention, the balancer has a spring carrier on which the compression spring is arranged in a rotationally fixed manner at the other of its ends and on which the rotation element is mounted in a rotatable manner and/or on which the balancer is able to be suspended, in particular on a cable and/or a snap hook.

In one configuration of the invention, the compression spring is arranged coaxially with the spindle mechanism and radially outside the circumference of the spindle, in particular—apart from the abutment element—also radially outside the circumference of the spindle nut. As a result of the use of, for example a single, compression spring which is arranged around the spindle mechanism, a very compact balancer can be achieved.

Within the meaning of the invention, the balancer can also have more than one, in particular 2, 3, 4, 6 or 8, compression springs which are arranged preferably parallel to one another and/or in an equally spaced manner in the circumference of the spindle mechanism. This can allow for example a uniformly distributed introduction of force into the spring carrier or the use of more favourable standard designs of compression springs in that the pressure force to be applied is distributed over a plurality of compression springs.

As a twist prevention means, for example when a plurality of compression springs are used, provision is preferably made for each of the compression springs to be arranged around a bolt which is firmly connected to the spring carrier.

In this case, in a preferred configuration, the translation element is connected to at least one of the bolts directly or indirectly by means of the abutment element in a rotationally fixed manner, but so as to be free in the compression direction, in order to ensure effective force transmission in the compression direction.

In one configuration of the invention, the rotation element is connected in a rotationally fixed manner to an, in particular cylindrical or conical, cable drum at the circumference of which an, in particular spiral-shaped, cable receptacle is arranged, to which a cable is fastened and guided several times around during operation of the balancer. Preferably, the component that is intended to be balanced in terms of weight is able to be suspended at the non-fastened end of the cable, for example on a snap hook. As a result, the spindle mechanism can be connected to the component such that a rotary movement is brought about by the acting gravitational force.

In one configuration of the invention, the rotation element is able to be temporarily decoupled (in particular in terms of rotation) from the cable drum, in particular by means of a setting device, and is rotatable with respect to the translation element. Thus, extension or compression of the compression spring, independently of the position of the cable pulley, can take place, with the result that it is easy to pre-set the counterforce to be applied.

### BRIEF DESCRIPTION OF THE DRAWINGS

Exemplary embodiments of the invention are described in more detail in the following text with reference to the appended drawings, in which:

FIG. 1 shows a front view of an example of a balancer according to the invention;

FIG. 2 shows a side view of the balancer from FIG. 1;

FIG. 3 shows a sectional view along the section A-A indicated in FIG. 1; and

FIG. 4 shows a rear view of the balancer from FIG. 1.

### DESCRIPTION OF THE FIGURES

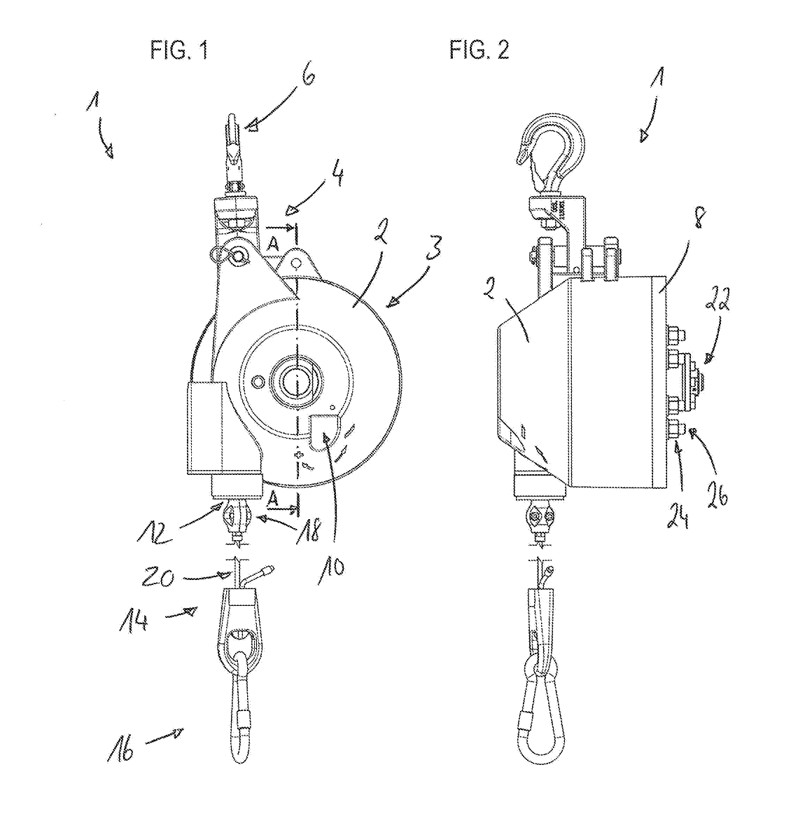

FIG. 1 shows a front view of a balancer 1 in the form of a spring balancer. In FIG. 2, the same balancer 1 is illustrated in a side view.

The external components of the balancer 1 can be seen in both figures. A suspension device 4 having a snap hook 6 is arranged on a housing component 2, configured in a pot-like manner, of a housing 3, it being possible to suspend the balancer 1 for example on a ceiling beam or on a frame by means of said suspension device 4.

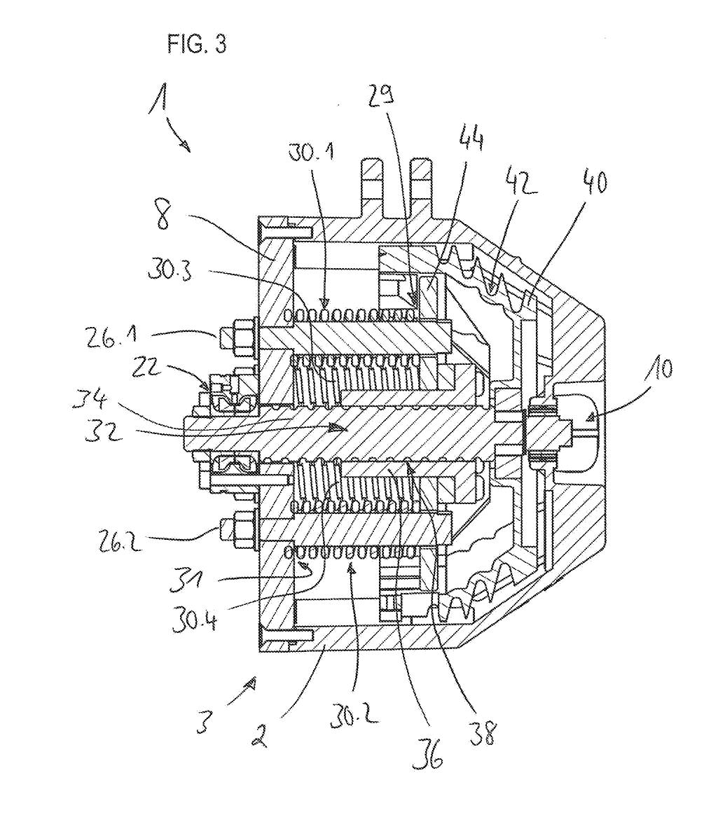

The housing 3 also has a spring carrier 8 which is configured as a housing cover and is screwed together with the housing component 2 in the exemplary embodiment (cf. FIG. 3). Also arranged on the housing component 2 is a setting device 10 for setting a preload of the compression springs.

The compression springs and the spindle mechanism are arranged inside the housing 3 and are therefore not visible in FIGS. 1 and 2.

From a not directly visible recess 12 in the housing 3 there extends a cable extension 14 having a snap hook 16 for suspending the component having the weight to be balanced (not illustrated), for example a manufacturing tool.

The cable extension 14 also has a cable lock 18 which limits retraction of the cable 20 of the cable extension 14 into the interior of the housing. The cable lock is appropriate in the exemplary embodiment because the compression springs are preloaded (that is to say already compressed in the rest state), and thus retract the cable when a component having a certain component weight is not fastened thereto.

It is additionally apparent from FIG. 2 that a spindle bearing 22 and fastening nuts 24 for bolts 26, which serve as a twist prevention means for the compression springs 30, are arranged on the spring carrier 8 configured as a housing cover.

FIG. 3 shows a sectional view along the section A-A indicated in FIG. 1, and thus the interior of the housing 3.

In the exemplary embodiment, six compression springs 30 are arranged in each case about a bolt 26, wherein the bolts are firmly connected to the spring carrier 8. The housing component 2 is in turn firmly connected to the spring carrier 8. Each of the compression springs 30 bears with its one end 29 against the receiving element 44 and with its other end 31 against the inner side of the spring carrier 8.

In the exemplary embodiment, a spindle mechanism 32 is arranged in the interior of the housing 3, which has a spindle 34 and a spindle nut 36. Arranged between the spindle 34 and the spindle nut 36 is a movement thread 38, configured as a ball screw, having a constant thread pitch (illustrated only in a very simplified schematic manner).

The spindle 34 is mounted in the spindle bearing 22 in a rotatable manner with respect to the spring carrier 8 and thus the compression springs 30 and—at least in the operating state—is connected to a cable drum 40 in a rotationally fixed manner. The cable drum 40 has a conical circumference and a spiral-shaped cable receptacle 42 in the exemplary embodiment; however, other exemplary embodiments having a cable drum with a cylindrical circumference are also provided.

An abutment element 44, which is configured as a circular perforated plate, has a through-hole for each bolt 26 and against which the compression springs 30 bear with their ends 29 under a compressive preload, is arranged at the spindle nut 36 in a rotationally fixed manner and around the entire circumference. The abutment element 44 is welded to the spindle nut 36 in the exemplary embodiment, but can also be firmly connected thereto in some other suitable way.

During operation of the balancer 1, it is thus possible for the cable drum 40 to be twisted together with the spindle 34 relative to the compression springs 30 that are rotationally fixed to the housing. This takes place during typical applications of the balancer 1, for example when a manufacturing tool or some other component having a relevant component weight is suspended in the hook 16. Then, via the cable extension 14, the cable 20 of which is guided in the cable receptacle 42 and is fastened thereto, the cable drum 40 is rotated on account of the acting gravitational force of the component. The pitch direction of the movement thread 38 is selected such that, during extension of the cable extension 14, the spindle nut 36 is moved to the left—in the drawing plane—that is to say equally towards the spring carrier 8. The compression springs 30 are compressed in that the movement in translation of the threaded nut 36 is transmitted to the springs via the abutment element 44.

With further deflection of the cable drum 40, the spindle 34 rotates ever further; the threaded nut 36 arranged in a manner rotationally fixed to the housing is in this case deflected proportionally ever further towards the left by the action of the movement thread 38. The compressive spring force applied to the abutment element 44 by the compression springs 30 increases linearly ever further with compression, in accordance with the spring force laws. This process only stops when the spring force, counteracting the weight force of the component, of the compression springs has increased to such an extent that it balances the weight force. In this state, the balancer can fulfill its functions mentioned at the beginning.

On that side of the housing 3 that is remote from the spring carrier 8, a setting device 10 can be provided, by means of which the rotationally fixed connection between the cable drum 40 and the spindle 34 can be suitably temporarily cancelled, and in this preload state, the spindle 34 can be rotated without the cable drum 40 being twisted, this resulting in displacement of the rest position, predefined by the cable lock 12, of the spindle nut 36 and thus in an altered preload of the balancer 1. The necessary rotary decoupling of the spindle 34 and of the cable drum 40 can take place for example via an engageable and disengageable spline toothing between the two components. The coupling mechanism is then part of the setting device 10.

Alternatively, the preload can also be changed by changing the position of the cable lock 12 along the cable 20.

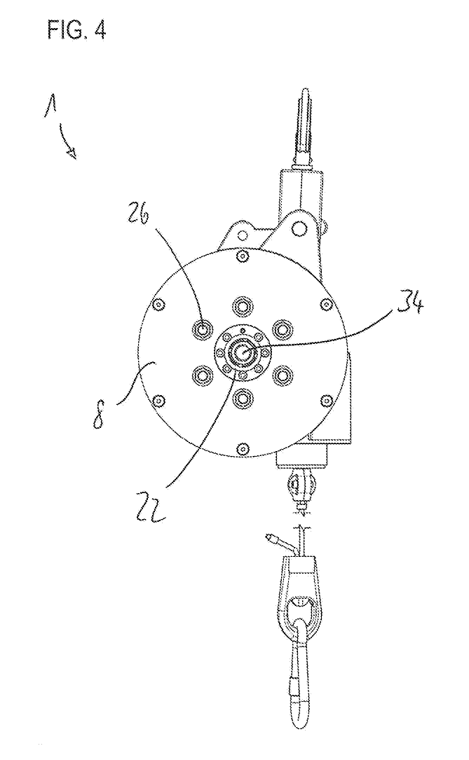

In FIG. 4, the balancer 1 from FIG. 1 is shown in a rear view. In this case, in particular the spring carrier 8, the bolts 26 and the spring bearing 22 are readily apparent. In addition, the uniform distribution of the bolts 26 and thus of the compression springs 30 in the circumference of the spindle 34 is apparent.

1. A balancer (1), in particular a spring balancer or a zero-gravity balancer, for a movable component with a component weight, having
a spindle mechanism (32) with a translation element (36) and a rotation element (34), on which the movable component can be suspended, and
at least one compression spring (30) which is connected, at one of its ends (29), to the translation element (36) of the spindle mechanism, wherein
the compression spring is able to be compressed by means of the translation element in the event of a rotation of the rotation element brought about by the component weight.

2. A balancer according to claim 1, wherein the spindle mechanism (32) has a movement thread (38).

3. A balancer according to claim 2, wherein the movement thread is in the form of a ball screw.

4. A balancer according to claim 2, wherein the movement thread is in the form of a roller screw.

5. A balancer according to claim 1, wherein the rotation element (34) has a spindle and the translation element (36) has a spindle nut.

6. A balancer according to claim 5, wherein the compression spring is arranged coaxially with the spindle mechanism and radially outside the circumference of the spindle.

7. A balancer according to claim 1, wherein the compression spring and the translation element are connected by means of an abutment element (44) which butts against one end (29) of the compression spring and is connected to the translation element.

8. A balancer according to claim 1, wherein a longitudinal axis of movement of the translation element extends parallel to the longitudinal axis of the compression spring.

9. A balancer according to claim 1, further comprising a spring carrier (8) on which the compression spring is arranged in a rotationally fixed manner at the other of its ends (31) and on which the rotation element is mounted in a rotatable manner.

10. A balancer according to claim 1, wherein more than one compression springs are arranged parallel to one another and in an equally spaced manner in the circumference of the spindle mechanism.

11. A balancer according to claim 10, wherein each of the compression springs is arranged around a bolt (26) which is firmly connected to the spring carrier.

12. A balancer according to claim 11, wherein the compression spring and the translation element are connected by means of an abutment element (44) which butts against one end (20) of the compression spring and is connected to the translation element, and, wherein the translation element is connected to at least one of the bolts directly or indirectly by means of the abutment element in a rotationally fixed manner, but so as to be free in the compression direction.

13. A balancer according to claim 1, wherein the rotation element is connected in a rotationally fixed manner to a cable drum (40).

14. A balancer according to claim 13, wherein the cable drum is cylindrical.

15. A balancer according to claim 13, wherein the cable drum is conical.

16. A balancer according to claim 13, wherein a cable receptacle (42) is arranged at the circumference of the cable drum (40).

17. A balancer according to claim 16, wherein the cable receptacle is spiral-shaped.

18. A balancer according to claim 13, wherein the rotation element is able to be temporarily decoupled in terms of rotation from the cable drum by means of a setting device (10) and is rotatable with respect to the translation element.
